(19) United States
(12) Patent Application Publication
(10) Pub. No.: US 2009/0122039 A1
(43) Pub. Date: May 14, 2009

(54) DISPLAY APPARATUS AND ELECTRONIC DEVICE PROVIDED WITH THE SAME

(76) Inventors: Hiromi Katoh, Nara (JP); Tomoyuki Nagai, Mie (JP); Yoshihiro Izumi, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/912,814

(22) PCT Filed: Apr. 20, 2006
(86) PCT No.: PCT/JP2006/308338

§ 371 Date: Dec. 22, 2008

(30) Foreign Application Priority Data
Apr. 28, 2005 (JP) 2005-132935

(51) Int. Cl. G09G 5/00

(52) U.S. Cl. 345/207; 345/32

(57) ABSTRACT

In a display apparatus having an active matrix substrate, a counter substrate provided so as to be opposed to a pixel array region of the active matrix substrate, and a display medium provided in a gap between the active matrix substrate and the counter substrate, an optical sensor (11) is provided in a peripheral region of the pixel array region in the active matrix substrate. In order to make it difficult for the optical sensor (11) to change with time, and suppress the influence of electromagnetic noise on the optical sensor (11), in an upper layer of the optical sensor (11), a surface protective film (24) is formed of a transparent insulation layer (20a) made of the same material as that of an interlayer insulation film in the pixel array region and having an effect of attenuating a UV-light transmittance and a transparent conductive layer (7a) formed of the same material as that of the pixel electrode in an upper layer of the transparent insulation layer (20a).

### TECHNICAL FIELD

The present invention relates to a flat panel type display apparatus such as a liquid crystal display apparatus and an electroluminescence (EL) display apparatus, and in particular, to a display apparatus having an environment sensor such as an optical sensor that detects the lightness of an ambient environment on an active matrix substrate. The present invention also relates to an electronic device provided with such a display apparatus.

### BACKGROUND ART

A flat panel type display apparatus such as a liquid crystal display apparatus has currently been incorporated in a wide range of information devices, TV devices, and amusement devices, such as a mobile telephone, a PDA, a DVD player, a mobile game device, a notebook PC, a PC monitor, and a TV due to the features of thinness, light weight, and low power consumption, and further due to the technical development for the enhancement of display performance such as coloring, increase in definition, and support for moving images.

In such a background, for the purpose of further enhancing visibility and reducing power consumption in a display apparatus, a display system has been proposed, which has an automatic light control function of automatically controlling the brightness of the display apparatus in accordance with the use environment, in particular, the brightness of ambient light.

For example, JP 4(1992)-174819 A and JP 5(1993)-241512 A disclose a method for providing an optical sensor that is a discrete component in the vicinity of a display apparatus, and automatically controlling the brightness of the display apparatus based on the use environment illuminance detected by the optical sensor. Consequently, the display brightness is increased in a light environment such as the daytime or the outdoor, and the display brightness is decreased in a relatively dark environment such as the nighttime and the indoor. Thus, the adjustment of a brightness (light control) can be performed automatically in accordance with the lightness of an ambient environment. In this case, a viewer of the display apparatus does not feel screen glare in a dark environment, whereby the visibility can be enhanced. Furthermore, irrespective of the lightness/darkness of a use environment, the reduction in power consumption and the increase in life of a display apparatus can be achieved, compared with a use method for keeping a display brightness to be high at all times. Furthermore, the adjustment of a brightness (light control) is performed automatically based on the detection information of an optical sensor, so that a user is not bothered.

As described above, the display system having an automatic light control function can satisfy both the satisfactory visibility and the reduction in power consumption with respect to the change in lightness of a use environment. Therefore, such a display system is particularly useful for mobile devices (a mobile telephone, a PDA, a mobile game device, etc.) which are likely to be used outdoors and require the driving of a battery.

On the other hand, JP 2002-62856 A discloses a configuration in which an optical sensor that is a discrete component is incorporated in a display apparatus. FIG. 7 is an entire configuration view of a liquid crystal display apparatus disclosed by JP 2002-62856 A, and FIG. 8 is a cross-sectional view of an optical sensor mounting portion thereof. The liquid crystal display apparatus has a configuration in which a substrate (active matrix substrate) 901 on which active elements such as thin film transistors (TFTs) are formed and a counter substrate 902 are attached to each other, and a liquid crystal layer 903 is interposed in a region surrounded by a frame-shaped sealing member 925 in a gap between the substrates. In a peripheral portion of the active matrix substrate 901, i.e., in a peripheral region S (frame region) where the counter substrate is not present, optical sensors 907 that are discrete components are provided. Light is incident upon the optical sensors 907 through openings 916 provided in a housing 915.

Thus, the configuration in which the optical sensors 907 are provided in the above peripheral region S has the following features. More specifically, in the case where a display mode of a liquid crystal display apparatus is a transmission type or a semi-transmission type, it is necessary to provide a backlight system 914 on a reverse surface of the active matrix substrate 901; however, the optical sensors 907 are provided in the above peripheral region S, so that light emitted by the backlight system 914 does not reach the optical sensors 907 directly, whereby a malfunction of the optical sensors 907 caused by the light emitted by the backlight system 914 can be minimized. Furthermore, in a normal liquid crystal display apparatus, a polarizing plate (not shown) is attached to a front side of the counter substrate 902; however, the optical sensors 907 are provided in the above peripheral region S, so that ambient light incident upon the optical sensors 907 is not blocked by the polarizing plate on the counter substrate 902, whereby a sufficient amount of ambient light can be introduced into the optical sensors. Consequently, the optical sensors 907 can obtain a high S/N.

Furthermore, recently, the technique of producing a display apparatus has advanced rapidly, and a technique of forming IC chips and various circuit elements, which are conventionally mounted in a peripheral portion of a display apparatus as discrete components, in a display apparatus (specifically on a glass substrate constituting the display apparatus) monolithically by the same process during formation of circuits and elements constituting the display apparatus has been established.

For example, JP 2002-175026 A discloses an example in which a vertical driving circuit, a horizontal driving circuit, a voltage conversion circuit, a timing generation circuit, an optical sensor circuit, and the like are formed in a peripheral region of a display region monolithically by the same process, when the display region is formed on a substrate. The monolithic formation of such discrete components in the display apparatus enables the reduction in a component count and a component mounting process, and can realize the miniaturization and reduction in cost of an electronic device incorporating the display apparatus. Needless to say, an optical sensor used for the adjustment of a brightness (light control) of a display apparatus, a circuit dedicated for an optical sensor (light amount detection circuit), and the like can also be formed monolithically in a display apparatus. JP 2002-62856 A also discloses an embodiment in which a peripheral circuit and an optical sensor are formed on a substrate constituting a display apparatus monolithically by the same process, in place of an optical sensor that is a discrete component.

As an active element used in an active matrix type display apparatus, a thin film transistor (TFT) using an amorphous Si film or a polycrystalline Si film is generally used. In the case of forming active elements and various circuit elements monolithically on the same substrate as described above, a TFT using a polycrystalline Si film is mainly used.

Referring to FIG. 9, the configuration of a TFT having a polycrystalline Si film as a semiconductor layer, formed on each pixel of a pixel array region (display region) will be described. The configuration of a TFT described herein is called a “top gate structure” or a “forward stagger structure”, and has a gate electrode in an upper layer of a semiconductor film (polycrystalline Si film) to be a channel.

A TFT 500 includes a polycrystalline Si film 511 formed on a glass substrate 510, a gate insulation film 512 formed so as to cover the polycrystalline Si film, a gate electrode 513 formed on the gate insulation film 512, and a first interlayer insulation film 514 formed so as to cover the gate electrode 513. A source electrode 517 formed on the first interlayer insulation film 514 is electrically connected to a source region 511c of a semiconductor film via a contact hole passing through the first interlayer insulation film 514 and the gate insulation film 512. Similarly, a drain electrode 515 formed on the first interlayer insulation film 514 is electrically connected to a drain region 511b of a semiconductor film via a contact hole passing through the first interlayer insulation film 514 and the gate insulation film 512. Furthermore, a second interlayer insulation film 518 is formed so as to cover them.

In such a configuration, a region of the semiconductor film opposed to the gate electrode 513 functions as a channel region 511a. Furthermore, regions of the semiconductor film other than the channel region 511a are doped with impurities in a high concentration, and function as the source region 511c and the drain region 511b.

Although not shown, in order to prevent the degradation in electric characteristics caused by hot carriers, a lightly doped drain (LDD) region doped with impurities in a low concentration is formed on a channel region side of the source region 511c and on a channel region side of the drain region 511b.

Furthermore, a pixel electrode 519 for supplying an electric signal to a display medium to be driven is formed in an upper layer of the second interlayer insulation film 518. The pixel electrode 519 is electrically connected to the drain electrode 515 via a contact hole provided in the second interlayer insulation film 518. The pixel electrode 519 is generally required to be flat in most cases, and the second interlayer insulation film 518 present in a lower layer of the pixel electrode 591 is required to have a function as a flattening film. Therefore, it is preferred that an organic film (thickness: 2 to 3 μm) made of acrylic resin is used for the second interlayer insulation film. Furthermore, for the purpose of forming a contact hole in the TFT 500 and taking out an electrode in a peripheral region, the second interlayer insulation film 518 is required to have patterning performance, and generally, an organic film having photosensitivity is used in most cases.

On the other hand, in the case where an optical sensor for detecting the brightness of ambient light is formed monolithically in a peripheral region of a display apparatus with a TFT having the above configuration in a display region, if an attempt is made so as to minimize the increase in a production process, the element configuration of the optical sensor is limited.

FIG. 10 is a view showing an element configuration cross-section of an optical sensor 400 satisfying these conditions. A semiconductor film 411 constituting the optical sensor is formed on a glass substrate 410, and a doped region (a p-region 411c or an n-region 411b) of the semiconductor film 411 is formed in a lateral direction (plane direction) instead of a vertical direction (stack direction) with respect to a non-doped region (an i-region 411a). Generally, a configuration having a PIN junction in the lateral direction (plane direction) with respect to a formation surface is called a PIN-type photodiode with a lateral structure.

Each member constituting the optical sensor 400 is formed by the same process as that of each member constituting the TFT shown in FIG. 9. For example, an insulation film 412 formed of the same material and by the same process as those of the gate insulation film 512 is formed in an upper layer of the semiconductor film 411, and a p-side electrode 417 formed of the same material and by the same process as those of the source electrode 517 and an n-side electrode 415 formed of the same material and by the same process as those of the drain electrode 515 are formed in an upper layer of the first interlayer insulation film 414.

Furthermore, in an upper layer of the p-side electrode 417 and the n-side electrode 415, a surface protective film 418 formed of the same material and by the same process as those of the second interlayer insulation film 518 is formed. In this case, in a pixel array region (display region), the second interlayer insulation film 518 plays a role of electrically insulating a layer for forming the TFT 500 from a layer for forming the pixel electrode 519, and enhancing the flatness of the surface of the pixel electrode 519. In a peripheral region (frame region) outside of the pixel array region (outside of the display region), the second interlayer insulation film 518 plays a role of protecting the optical sensor 400 and electrodes connected to the optical sensor 400 from outside air as the surface protective film 418 of the active matrix substrate. Thus, the second interlayer insulation film 518 also functions as the surface protective film 418, and is generally formed substantially over the entire surface from the display region to the peripheral region.

The optical sensor 400 shown in FIG. 10 can be used in place of the optical sensor 907 (a discrete component provided in a peripheral region) of a conventional display apparatus shown in FIG. 7, and can reduce a component count and a component mounting process, when the display apparatus shown in FIG. 7 is incorporated in an electronic device.

### DISCLOSURE OF INVENTION

### Problem to be Solved by the Invention

However, it was clarified that if an attempt is made so as to realize a display apparatus by forming the above-mentioned optical sensor shown in FIG. 10 in a peripheral region of an active matrix substrate, the following problems occur.

An active matrix substrate constituting a display apparatus is roughly classified into a display region (H shown in FIG. 8) and a peripheral region (frame region) (S shown in FIG. 8), and the latter peripheral region (S) can be further divided into a light shielding region (S1) shielded against light by the housing, and a non-light shielding region (S2) that is positioned in an opening (for example, corresponding to the opening 916 in FIG. 8) provided in the housing and receiving incidence of ambient light. The above-mentioned optical sensor needs to receive ambient light, so that the optical sensor needs to be placed in the non-light shielding region (S2) on the active matrix substrate.

In the above, it has been described that the second interlayer insulation film is formed substantially over the entire surface from the display region to the peripheral region. The ambient light (assuming the outdoor use under solar light) reaching the second interlayer insulation film will be considered as follows.

Display region (H): A part of ambient light is absorbed by a polarizing plate (not shown) and a color filter provided on a counter substrate, so that the ambient light reaching the second interlayer insulation film on the active matrix substrate is limited to light in a particular wavelength region. In particular, about 100% of UV-light is absorbed by the polarizing plate or the color filter, so that there is no UV-light reaching the second interlayer insulation film.

Light shielding region (S1): The whole ambient light is blocked by the housing. Needless to say, there is no UV-light reaching the second interlayer insulation film on the active matrix substrate.

Non-light shielding region (S2): Ambient light is directly incident, so that light (containing UV-light) with a whole wavelength contained in ambient light reaches the second interlayer insulation film on the active matrix substrate.

That is, considering the case where the display apparatus is used outdoors, UV-light contained in solar light can reach the second interlayer insulation film on the active matrix substrate only in the non-light shielding region (S2) of the peripheral region.

As described above, the second interlayer insulation film is formed of an organic film having photosensitivity made of acrylic resin or the like. The organic film used herein contains a photosensitive group absorbing UV-light so as to be patterned by exposure to UV-light, and is made of a material that is likely to effect a polymerization reaction or a collapse reaction of a polymer by exposure to UV-light. Therefore, the organic film has properties of being likely to absorb UV-light and being likely to be degraded, compared with an ordinary resin material. Thus, regarding the organic film used herein, the resistance to UV-light has not been considered.

When a light resistance test of the second interlayer insulation film positioned in the non-light shielding region (S2) was conducted to find that the following phenomenon occurs: a film is degraded due to the irradiation of UV-light for a long period of time, that is, a film which is originally transparent is turned to dark brown or clouded, and is peeled finally. Furthermore, it was found that, as a result of the above, the transparency of the second interlayer insulation film is impaired, ambient light reaching the optical sensor positioned under the second interlayer insulation film decreases to cause the sensitivity failure of the optical sensor and the change in characteristics with the passage of time, and furthermore, the protective film is peeled. This phenomenon is a problem related to the reliability of the display apparatus provided with an optical sensor, which is required to be solved.

As a method for solving such a problem, it is effective to enhance resistance to UV-light of the second interlayer insulation film. However, there is apprehension that the tradeoff of performance may occur when the resin material for the existing second interlayer insulation film, which has already been optimized with respect to other requirement specifications such as large area coating performance, a patterning property, flatness, and heat resistance with respect to a process temperature, is further improved. Thus, there is a demand for measures by the other methods assuming that the current second interlayer insulation film is used.

On the other hand, when the above-mentioned optical sensor shown in FIG. 10 is formed in a peripheral region on an active matrix substrate to realize a display apparatus, each electrode of the optical sensor, wiring members of a peripheral circuit, and the like are exposed to the atmosphere only through a thin insulation film. Therefore, there is a problem in that the display apparatus is weak to electromagnetic noise, and particularly, the influence of the electromagnetic noise cannot be ignored since the optical sensor generally deals with a very weak current in the order of pA to nA.

It is an object of the present invention to provide an active matrix substrate and a display apparatus having an environment sensor (e.g., an optical sensor) formed in a peripheral region of the active matrix substrate, wherein the display apparatus uses a layer made of the same material as that of the interlayer insulation film (second interlayer insulation film) in a pixel array region as a surface protective film of the environment sensor, prevents the surface protective film from being denatured, and is strong to electromagnetic noise.

### Means for Solving Problem

In order to achieve the above object, a display apparatus according to the present invention includes: an active matrix substrate having a pixel array region in which a plurality of pixels are arranged; a counter substrate placed so as to be opposed to the pixel array region of the active matrix substrate; and a display medium placed in a gap between the active matrix substrate and the counter substrate, wherein in the pixel array region of the active matrix substrate, a plurality of electrode wires, a plurality of active elements, an interlayer insulation film provided in an upper layer of the plurality of electrode wires and the plurality of active elements, and a plurality of pixel electrodes formed on the interlayer insulation film, the display apparatus including an environment sensor provided in a peripheral region present on a periphery of the pixel array region in the active matrix substrate, and a surface protective film provided in an upper layer of the environment sensor, wherein the surface protective film includes a transparent insulation layer formed of the same material as that of the interlayer insulation film in the pixel array region, and a transparent conductive layer formed of the same material as that of the pixel electrode in an upper layer of the transparent insulation layer.

According to the above configuration, the surface protective film placed in the upper layer of the environment sensor includes the transparent insulation layer formed of the same material as that of the interlayer insulation film and the transparent conductive layer formed in the upper layer of the transparent insulation layer. The above interlayer insulation film is used for insulating the electrode wires and the plurality of active elements from the pixel electrodes provided in the upper layer of the electrode wires and the plurality of active elements in the pixel array region. The display apparatus of the present invention includes the transparent conductive layer as a part of the surface protective film in the upper layer of the environment sensor, thereby suppressing the influence of electromagnetic noise on the environment sensor. Furthermore, due to the presence of the transparent conductive layer, the transparent insulation layer formed of the same material as that of the interlayer insulation film in the pixel array region can be prevented from being denatured by UV-light contained in ambient light. Thus, an environment sensor with satisfactory sensitivity and a small change in characteristics with time can be realized. Consequently, a highly reliable display apparatus can be provided.

In the above display apparatus, it is preferred that at least partial constituent members of the environment sensor are produced by the same process as that of constituent members of the active elements. This is because the production process is simplified and the cost can be reduced.

In the above display apparatus, it is preferred that the environment sensor is formed monolithically on a principal plane of the active matrix substrate. Herein, the environment sensor being “formed monolithically” on the active matrix substrate does not include the case where the environment sensor is mounted on the active matrix substrate as a discrete component. More specifically, the environment sensor being “formed monolithically” on the active matrix substrate means that the environment sensor is formed on a principal plane of the active matrix substrate through the step in which the active matrix substrate is directly subjected to the physical and/or chemical process such as film formation treatment and etching treatment.

In the above display apparatus, it is preferred that the interlayer insulation film and the transparent insulation layer are formed by the same process, and the pixel electrodes and the transparent conductive layer are formed by the same process. This is because the number of production steps does not need to be increased, which can suppress the production cost of the display apparatus.

In the above display apparatus, for example, thin film transistors can be used as the above active elements, and a photodiode having a lateral structure can be used as the above environment sensor.

In the above display apparatus, it is preferred that the transparent conductive layer attenuates a transmittance of UV-light contained in ambient light to 50% or less. This is because the change in the transparent insulation layer with time due to UV-light can be suppressed effectively. For example, in the case where the transparent conductive layer is an indium-tin oxide, if a thickness thereof is 140 nm or more, the transmittance of the transparent conductive layer with respect to UV-light can be attenuated to about 50% or less.

In the above display apparatus, it is preferred that the transparent conductive layer is electrically insulated from the pixel electrode, and is connected to a predetermined fixed potential. The reason for this is as follows. The transparent conductive layer functions as an electromagnetic wave shield of the environment sensor, so that the resistance to electromagnetic noise of the environment sensor and an S/N ratio are enhanced, whereby the environment sensor can perform sensing with higher precision, which can prevent the malfunction of peripheral circuits.

Furthermore, in order to achieve the above object, an electronic device according to the present invention has the display apparatus according to any of the above-mentioned configurations, wherein the environment sensor is an optical sensor, and the electronic device includes a control circuit controlling a display brightness in accordance with lightness information of ambient light detected by the optical sensor. For example, in the case of a display apparatus provided with a backlight system, the control of the display brightness can be realized when the control circuit controls the brightness of the backlight system. Furthermore, in the case where the display apparatus is a self-light emitting element, the control of the display brightness can be realized when the control circuit controls an emission brightness. Thus, by controlling the display brightness so as to obtain a necessary and sufficient brightness in accordance with the lightness of the circumstance, an electronic device that reduces power consumption and realizes an easy-to-see display can be provided. The electronic device can satisfy both the satisfactory visibility and the reduction in power consumption with respect to the change in lightness of a use environment, so that it is particularly useful as a mobile device which is likely to be used outdoors and requires the driving of a battery. Examples of such a mobile device are not limited to the application of the present invention, and include, for example, an information terminal such as a mobile telephone and a PDA, a mobile game device, a portable music player, a digital camera, and a video camera.

Furthermore, in order to achieve the above object, an active matrix substrate according to the present invention having a pixel array region in which a plurality of pixels are arranged includes: in the pixel array region, a plurality of electrode wires, a plurality of active elements, an interlayer insulation film provided in an upper layer of the plurality of electrode wires and a plurality of active elements, and a plurality of pixel electrodes formed on the interlayer insulation film; an environment sensor provided in a peripheral region present on a periphery of the pixel array region in the active matrix substrate; and a surface protective film provided in an upper layer of the environment sensor, wherein the surface protective film includes a transparent insulation layer having an effect of attenuating a UV-light transmittance, formed of the same material as that of the interlayer insulation film in the pixel array region, and a transparent conductive layer formed of the same material as that of the pixel electrode in an upper layer of the transparent insulation layer.

### EFFECTS OF THE INVENTION

As described above, according to the present invention, a display apparatus having an environment sensor (e.g., an optical sensor) formed in a peripheral region of an active matrix substrate and an electronic device can be provided, in which the display apparatus uses a layer made of the same material as that of the interlayer insulation film (second interlayer insulation film) in a pixel array region as a surface protective film of the environment sensor, prevents the surface protective film from being denatured, and is strong to electromagnetic noise.

### BRIEF DESCRIPTION OF DRAWINGS

FIG. 1 is a perspective view showing an entire configuration of a display apparatus according to First Embodiment of the present invention.

FIG. 2 is a cross-sectional view showing a state in which the display apparatus according to First Embodiment is incorporated in a housing.

FIG. 3 is a cross-sectional view showing a configuration per pixel in a pixel array region (display region) of the display apparatus according to First Embodiment.

FIG. 4 is a cross-sectional view showing an example of a configuration of an optical sensor portion of the display apparatus according to First Embodiment.

FIG. 5 is a graph showing a relationship between the film thickness of ITO and the spectroscopic transmittance.

FIG. 6 is a block diagram showing a schematic configuration of an electronic device according to Second Embodiment of the present invention.

FIG. 7 is an entire configuration view of a conventional liquid crystal display apparatus disclosed by JP 2002-62856 A.

FIG. 8 is a cross-sectional view of an optical sensor mounting portion disclosed by JP 2002-62856 A.

FIG. 9 is a cross-sectional configuration view of a conventional TFT formed in a pixel array region of an active matrix substrate.

FIG. 10 is an element configuration cross-sectional view of a conventional optical sensor.

### DESCRIPTION OF THE INVENTION

Hereinafter, a display apparatus according to an embodiment of the present invention will be described with reference to the drawings. In the present embodiment, a liquid crystal display apparatus will be illustrated as an example of a display apparatus; however, the present invention is also applicable to a display apparatus other than the liquid crystal display apparatus.

### First Embodiment

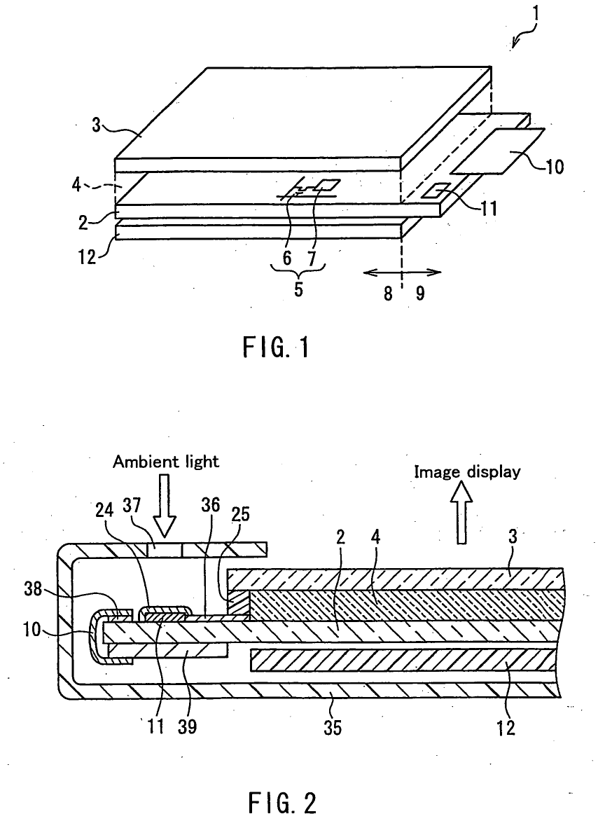

FIG. 1 is an entire configuration view of a display apparatus 1 according to one embodiment of the present invention. The display apparatus 1 includes an active matrix substrate 2 on which a number of pixels are arranged in a matrix, and a counter substrate 3 placed so as to be opposed to the active matrix substrate 2, and liquid crystal that is a display medium 4 is interposed in a gap between the substrates. The active matrix substrate 2 and the counter substrate 3 are bonded to each other with a frame-shaped seal resin (not shown) along an outer periphery of the counter substrate 3.

In each pixel 5 of the active matrix substrate 2, a thin film transistor (TFT) 6 and a pixel electrode 7 for driving the display medium 4 are formed. The counter substrate 3 is provided with a counter electrode (not shown) and a color filter (not shown).

The active matrix substrate 2 includes a region (pixel array region) 8 in which the pixels 5 are arranged, and a peripheral region 9 dose to the pixel array region, and the counter substrate 3 is provided so as to cover the pixel array region 8 and to expose a part of the peripheral region 9.

In the peripheral region 9 of the active matrix substrate 2, an FPC 10 for connecting an external driving circuit to the display apparatus is mounted via a terminal 38 (see FIG. 2), and furthermore, an optical sensor 11 for detecting the brightness of ambient light is provided as an environment sensor. In addition, peripheral circuits (a driving circuit (not shown) for driving the TFT 6 in the pixel array region 8, wires (not shown) connected to the optical sensor 11 and the driving circuit, lead wires (not shown) from the pixel array region 8, etc.) are also provided.

The TFT 6 formed in the pixel array region 8 and the optical sensor 11 formed in the peripheral region 9 are formed on the active matrix substrate 2 monolithically by almost the same process. That is, partial constituent members of the optical sensor 11 are formed simultaneously with partial constituent members of the TFT 6.

In FIG. 1, an example is shown in which one optical sensor 11 is placed in the peripheral region 9 of the display apparatus 1, and the FPC 10 is placed next to the optical sensor 11. However, the arrangement position of the optical sensor 11 and the number thereof, and the arrangement position of the FPC 10 are not limited to the example shown in FIG. 1. For example, a plurality of optical sensors 11 may be provided in the peripheral region 9.

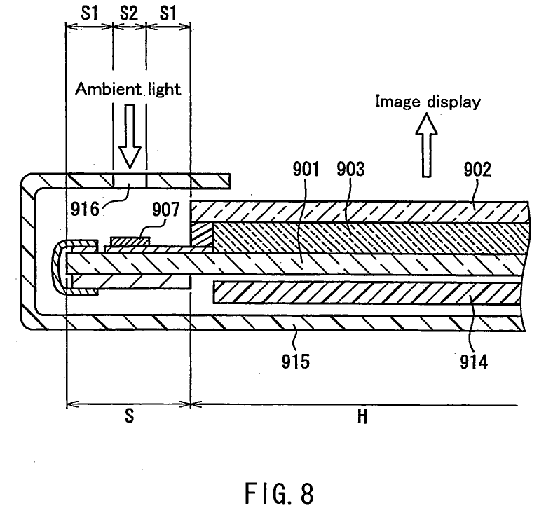

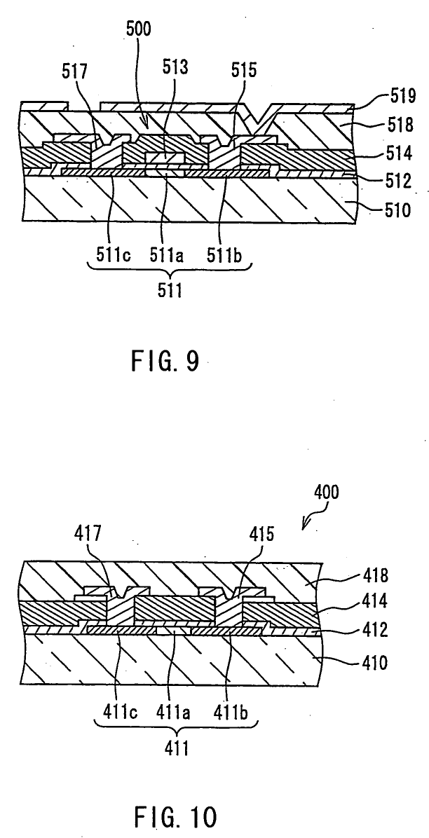

As shown in FIG. 2, the display apparatus 1 shown in FIG. 1 is incorporated in a housing 35 with an opening in the same way as in the display apparatus shown in FIG. 8 of the conventional example. An opening 37 of the housing 35 is provided at a predetermined position, and ambient light reaches the above optical sensor 11 through the opening 37. Reference numeral 39 in FIG. 2 denotes a circuit board.

In the case of a display mode in which the display apparatus uses transmitted light, it is necessary that a backlight system 12 is provided on a reverse surface side of the active matrix substrate 2 in the housing 35. Needless to say, in the case of using liquid crystal utilizing a reflection display mode that utilizes the reflection of ambient light, and in the case of using a self-light emitting element such as an EL as a display medium, a backlight system is not required.

Furthermore, the optical sensor 11 has an object of detecting ambient light; therefore, when light of the backlight system 12 is incident upon the optical sensor 11, there arises a problem that the optical sensor 11 malfunctions. Thus, care should be taken so that the backlight system 12 is not placed on a lower side of an optical sensor placement portion of the active matrix substrate 2, or a light-shield member (not shown) such as an aluminum tape is provided on a reverse surface of the optical sensor placement portion of the active matrix substrate 2.

The display apparatus 1 of the above embodiment can be applied to a display system with an automatic light control function that detects the illuminance of ambient light with the optical sensor 11, and automatically controls a display brightness in accordance with the detected illuminance. That is, by providing a control circuit for controlling the brightness of the backlight system 12 and a brightness signal of a display signal based on the lightness information of ambient light output from the optical sensor 11 provided in the peripheral region 9 of the above active matrix substrate 2, the display brightness of the display apparatus 1 can be controlled automatically. Consequently, the adjustment of a brightness (light control) can be performed automatically so that the display brightness is increased in a light environment such as the outdoor, and the display brightness is decreased in a relatively dark environment such as the nighttime and the indoor, whereby the reduction in power consumption and the increase in life of the display apparatus can be realized.

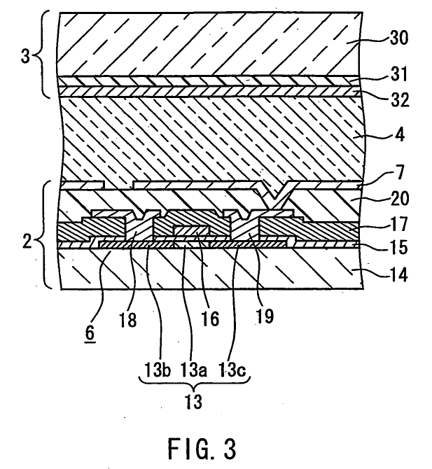

Next, the detailed configuration of the display apparatus 1 of the present embodiment will be described with reference to FIGS. 1, 3, and 4. FIG. 3 is a cross-sectional configuration view per pixel of the pixel array region (display region) 8 in the display apparatus 1 shown in FIG. 1. The display medium (liquid crystal) 4 is interposed in a gap between the active matrix substrate 2 and the counter substrate 3. The active matrix substrate 2 is provided with the thin film transistor (TFT) 6 and the pixel electrode 7 for driving the display medium.

Hereinafter, the configurations of the TFT 6 using a polycrystalline Si film used in the present embodiment and the pixel 5 including the TFT 6 will be described with reference to FIGS. 1 to 3. The configuration of the TFT 6 used herein is called a “top gate structure” or a “forward stagger structure”, and includes a gate electrode in an upper layer of the semiconductor film (polycrystalline Si film) 13 to be a channel.

Non-alkali barium borosilicate glass, aluminoborosilicate glass, or the like is used for a glass substrate 14 that is a base member. The TFT 6 includes a polycrystalline Si film 13 formed on the glass substrate 14, a gate insulation film 15 (a silicon oxide film, a silicon nitride film, etc.) formed so as to cover the polycrystalline Si film 13, a gate electrode 16 (Al, Mo, Ti, or an alloy thereof) formed on the gate insulation film, and a first interlayer insulation film 17 (a silicon oxide film, a silicon nitride film) formed so as to cover the gate electrode.

Herein, in the polycrystalline Si film 13, a region opposed to the gate electrode 16 via the gate insulation film 15 functions as a channel region 13a. Furthermore, regions of the polycrystalline Si film 13 other than the channel region are n⁺ layers doped with impurities in a high concentration, which function as a source region 13b and a drain region 13c. Although not shown, in order to prevent the degradation in electrical characteristics caused by hot carriers, a lightly doped drain (LDD) doped with impurities in a low concentration is formed on a channel region side of the source region 13b and a channel region side of the drain region 13c.

A base coat film (for example, a silicon oxide film, a silicon nitride film, or the like can be used) may be provided on the surface (under the polycrystalline Si film 13) of the glass substrate. Furthermore, the polycrystalline Si film 13 can be obtained by crystallizing a semiconductor film (an amorphous Si film) having an amorphous configuration by heat treatment such as laser annealing, rapid thermal annealing (RTA), or the like.

A source electrode 18 (for example, Al, Mo, Ti, or an alloy thereof can be used) formed on the first interlayer insulation film 17 is electrically connected to the source region 13b of the polycrystalline Si film 13 via a contact hole passing through the first interlayer insulation film 17 and the gate insulation film 15. Similarly, a drain electrode 19 (for example, Al, Mo, Ti, or an alloy thereof can be used) formed on the first interlayer insulation film 17 is electrically connected to the drain region 13c of the polycrystalline Si film 13 via a contact hole passing through the first interlayer insulation film 17 and the gate insulation film 15.

Up to this point, the basic configuration of the TFT 6 used herein has been described. In the pixel array region (display region) 8, a second interlayer insulation film 20 is further formed so as to cover the TFT 6. Herein, the second interlayer insulation film 20 is required to play a role of flattening the unevenness of a lower layer as well as providing insulation between layers. Therefore, an organic film (for example, an organic insulation film made of acrylic, polyimide, or the like) capable of being formed by coating or printing is mainly used.

Furthermore, the pixel electrode 7 (for example, indium-tin oxide (ITO), indium-zinc oxide (IZO), etc.) is formed in an upper layer of the second interlayer insulation film 20. The pixel electrode 7 is electrically connected to the drain electrode 19 via a contact hole formed in the second interlayer insulation film 20. It is preferable to use an organic insulation film having photosensitivity as the second interlayer insulation film 20, and a contact hole can be formed easily in the second interlayer insulation film 20 by exposure to light through a mask and development. Examples of the organic insulation film having photosensitivity include acrylic, polyimide, and benzo-cyclo-butene (BCB).

In FIG. 3, reference numeral 30 denotes a glass substrate that is a base substrate of the counter substrate 3, 31 denotes a color filter, and 32 denotes a counter electrode formed over the entire surface of the counter substrate 3.

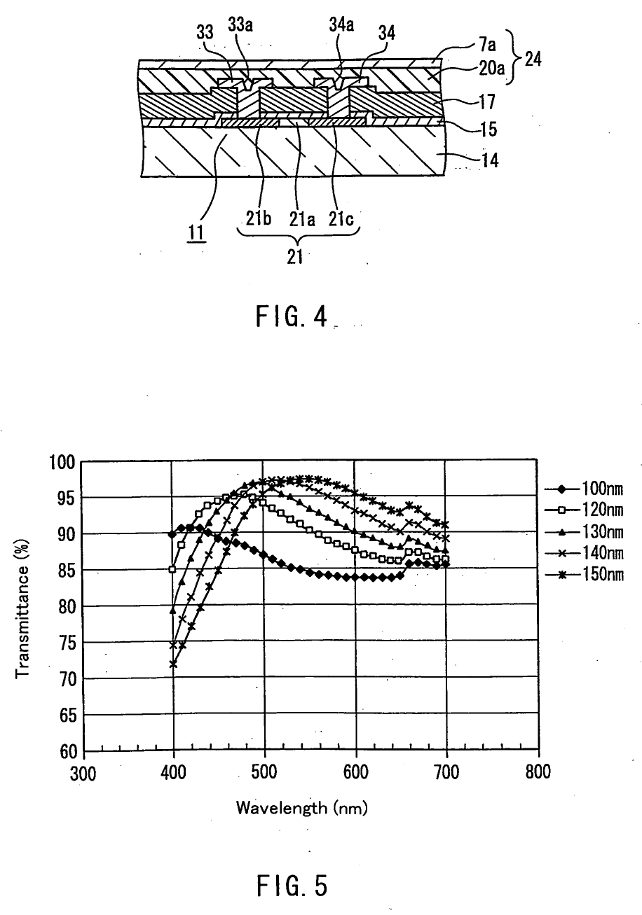

FIG. 4 is a cross-sectional configuration view of the optical sensor 11 formed in the peripheral region 9.

Hereinafter, the configuration of the optical sensor 11 will be described with reference to FIG. 4. The configuration of the optical sensor 11 used herein is called a “photodiode with a lateral structure”, which includes a diode in which a PIN junction of a semiconductor is formed in a plane direction (lateral direction) of a substrate.

In the optical sensor 11 shown in FIG. 4, a PIN diode of the polycrystalline Si film 21 is formed on the glass substrate 14 (a substrate common to the substrate on which TFTs are formed) to be a base member. The polycrystalline Si film 21 of the optical sensor 11 is formed simultaneously with and by the same process as that of the polycrystalline Si film 13 (see FIG. 3) of the TFT 6 in the pixel array region 8 (display region). Therefore, the polycrystalline Si film 13 and the polycrystalline Si film 21 have the same thickness.

The PIN junction is formed of a p⁺ layer (region 21b) and an n⁺ layer (region 21c) doped with impurities in a high concentration, and an i layer (region 21a) that is not doped with impurities. A p⁻ layer and an n⁻ layer doped in a low concentration can also be used alone or in combination in place of the i layer.

Furthermore, the gate insulation film 15 (a silicon oxide film, a silicon nitride film, etc.) and the first interlayer insulation film 17 (a silicon oxide film or a silicon nitride film) are formed so as to cover the polycrystalline Si film 21 having a PIN junction. The gate insulation film 15 and the first interlayer insulation film 17 shown in FIG. 4 are the gate insulation film 15 of the TFT 6 and the first interlayer insulation film 17 in the pixel array region 8 (see FIG. 3), which extend to the peripheral region 9.

A p-side electrode 33 (for example, Al, Mo, Ti, or an alloy thereof can be used) formed on the first interlayer insulation film 17 is electrically connected to the p⁺ region 21b of the polycrystalline Si film 21 via a contact hole passing through the first interlayer insulation film 17 and the gate insulation film 15. Similarly, an n-side electrode 34 (for example, Al, Mo, Ti, or an alloy thereof can be used) formed on the first interlayer insulation film 17 is electrically connected to the n⁺ region 21c of the polycrystalline Si film 21 via a contact hole passing through the first interlayer insulation film 17 and the gate insulation film 15. In the p-side electrode 33 and the n-side electrode 34, a portion exposed to the surface of the first interlayer insulation film 17 is an electrode portion of the optical sensor 11.

The formation of contact holes in the first interlayer insulation film 17 and the gate insulation film 15 in the peripheral region 9 is performed simultaneously with and by the same process as that of the formation of contact holes in the first interlayer insulation film 17 and the gate insulation film 15 in the pixel array region 8. Furthermore, the formation of the p-side electrode 33 and the n-side electrode 34 is performed simultaneously with and by the same process as that of the formation of the source electrode 18 and the drain electrode 19 of the TFT 6.

Up to this point, the basic configuration of the optical sensor 11 has been described. The constituent members of the optical sensor 11 are basically the same as those of the TFT 6 in the above-mentioned pixel array region, and the production process thereof is also common. Thus, in the active matrix substrate 2, the TFT 6 in the pixel array region 8 and the optical sensor 11 in the peripheral region 9 are formed monolithically.

In the peripheral region 9, in addition to the above-mentioned optical sensor 11, peripheral circuits (a driving circuit (not shown) for driving the TFT 6 in the pixel array region 8, wires 36 connected to the optical sensor 11 and the driving circuit, lead wires (not shown) from the pixel array region 8, etc.) are also formed.

Then, as shown in FIG. 4, the second interlayer insulation film 20 in the pixel array region 8 extends to an upper layer of the optical sensor 11, the above driving circuit, and various wires in the peripheral region 9. In other words, a transparent insulation layer 20a made of the same material as that of the second interlayer insulation film 20 in the pixel array region 8 is provided in an upper layer of the optical sensor 11 and the like. More specifically, the transparent insulation layer 20a plays a role as a surface protective film 24 of the optical sensor 11 and the like together with a transparent conductive layer 7a described below in the peripheral region 9. In the configuration shown in FIG. 4, although concave portions 33a, 34a for enhancing the adhesion to the transparent insulation layer 20a are formed in the respective top portions of the p-side electrode 33 and the n-side electrode 34, they may not be necessarily required.

Furthermore, in an upper layer of the transparent insulation layer 20a, the transparent conductive layer 7a is formed. The transparent conductive layer 7a may be made of a conductive member transmitting a visible region while having a function of attenuating the transmittance of UV-light contained in light in ambient light. The transparent conductive layer 7a is not limited thereto, and can be formed using, for example, a conductive oxide film made of ITO, IZO, ZnO, SnO₂, or the like, or a coating-type electrode material in which fine particles of ITO, IZO, ZnO, SnO₂, or the like is dispersed. As the transparent conductive layer 7a, a metal thin film (e.g., a half mirror) can also be used. It is preferred that the transparent conductive layer 7a has a function of attenuating the transmittance of UV-light contained in light in ambient light to at least less than 50%. The transparent conductive layer 7a having a function of attenuating the transmittance of UV-light to less than 10% is more preferred.

Furthermore, the formation of the transparent conductive layer 7a of the same material as that of the pixel electrode 7 in the pixel array region 8 is particularly useful because the transparent conductive layer 7a can be formed in the same step as that of the pixel array region 8, whereby the process does not increase.

FIG. 5 shows a general spectroscopic transmittance of an ITO film that is an example of the material for the pixel electrode 7 and the transparent conductive layer 7a. In general, an ITO film with a thickness of about 150 nm absorbs 50% or more of UV-light in a range of 380 nm or less. As shown in FIG. 5, the central wavelength with a satisfactory transmittance of the ITO film having a thickness of about 150 nm is in the vicinity of 550 nm, and the spectroscopic characteristics in a visible range of the ITO film is satisfactory, i.e., close to visibility. Thus, in the case of using ITO as the material for the pixel electrode 7 and the transparent conductive layer 7a, the thickness of ITO is preferably 140 nm or more. In accordance with the UV-light resistance characteristics of the transparent insulation layer 20a, as the UV-light resistance characteristics of the transparent insulation layer 20a is lower, the thickness of an ITO film as the transparent conductive layer 7a should be larger. In the case of using a material other than ITO as a material for the pixel electrode 7 and the transparent conductive layer 7a, it is preferred to set the thickness of the material so that the spectroscopic transmittance comparable to that of the ITO film with a thickness of 140 nm or more can be obtained.

Furthermore, the pixel electrode 7 may be patterned after a material (e.g., an ITO film) for the pixel electrode 7 is formed in the pixel array region 8 so that the pixel electrode 7 in the pixel array region 8 and the transparent conductive layer 7a in the peripheral region 9 are simultaneously insulated electrically, and the transparent conductive layer 7a in the peripheral region 9 is connected to a fixed potential (e.g., 0 V). By doing so, the transparent conductive layer 7a plays a role of an electromagnetic shield with respect to the optical sensor 11 and the peripheral circuit covered with the transparent insulation layer 20a. Consequently, the resistance to electromagnetic noise of the optical sensor 11, and an S/N ratio are enhanced, whereby light sensing with higher precision can be performed, which can also prevent the malfunction of peripheral circuits.

As described above, the display apparatus 1 of the present embodiment has the following main features: the active matrix substrate 2 includes the pixel array region (display region) and the peripheral region 9; the optical sensor 11 detecting the brightness of ambient light is formed in the peripheral region 9; the transparent insulation layer 20a made of the same material as that of the second interlayer insulation film 20 in the pixel array region 8 is also formed in an upper layer of the optical sensor 11 in the peripheral region 9; the transparent conductive layer 7a having an effect of attenuating the transmittance of UV-light, made of the same material as that of the pixel electrode 7, is formed in an upper layer of the transparent insulation layer 20a; the transparent conductive layer 7a is electrically insulated from the pixel electrode 7 in the pixel array region 8; and the transparent conductive layer 7a in the peripheral region 9 is connected to a fixed potential. These features according to the present embodiment do not limit the present invention.

As described above, the display apparatus of the present embodiment further includes the transparent conductive layer 7a having an effect of attenuating the transmittance of UV-light in the upper layer of the transparent insulation layer 20a provided on the optical sensor 11. Therefore, the change in color of the transparent insulation layer 20a caused by UV-light can be alleviated (or eliminated) even if ambient light contains UV-light. Furthermore, the transparent conductive layer 7a is electrically insulated from the pixel electrode 7 in the pixel array region 8, and is connected to a fixed potential, thereby functioning as an electromagnetic shield. Thus, the influence of electromagnetic wave noise on the optical sensor 11 is alleviated, and the change in brightness of ambient light can be detected stably with high precision and exactness over a long period of time. Furthermore, as in the conventional example, in the case where the upper layer of the optical sensor is protected by only the second interlayer insulation film, it is necessary to design the optical sensor with excessive specs, in expectation of the degradation (decrease in a transmittance) in the second interlayer insulation film caused by UV-light. However, in the present embodiment, it is not necessary to consider the decrease in a transmittance of the second interlayer insulation film 20, whereby the optical sensor 11 can be appropriately designed. Therefore, the optical sensor 11 can be reduced in size compared with the conventional example. Consequently, the area of the peripheral region 9 in which the optical sensor 11 is placed can be minimized, which contributes to narrowing of the frame of the display apparatus. Furthermore, it is not necessary to allow the housing to have an electromagnetic shied effect, when the display apparatus is mounted on the electronic device, whereby the entire electronic device can be miniaturized.

In the display apparatus of the present embodiment, it is preferred that the transparent insulation layer 20a and the transparent conductive layer 7a extend to even an upper layer of the driving circuits (e.g., a gate driver, a source driver, etc.) formed monolithically in the peripheral region 9 of the active matrix substrate 2. These drivers are formed below the counter substrate 3 (i.e., a portion closer to the pixel array region 8, compared with a portion where the optical sensor 11 is provided) in the peripheral region 9 of the active matrix substrate 2. The upper layer of these drivers is also covered with the transparent insulation layer 20a and the transparent conductive layer 7a respectively made of the same materials as those of the second interlayer insulation film 20 and the pixel electrode 7, whereby a moisture-proof and dust-proof effect and an electromagnetic shield effect are obtained even with respect to these drivers.

In the above embodiment, although an example has been described in which the TFT 6 and the optical sensor 11 are formed using a polycrystalline Si film, both of them can also be formed using an amorphous Si film. Furthermore, a TFT with a bottom gate structure (reverse stagger structure) may be used instead of a TFT with a top gate structure (forward stagger structure). Furthermore, other active elements such as a metal-insulator-metal (MIM) can also be used in place of the TFT 6.

Furthermore, as the optical sensor, a photodiode having a Schottky junction or an MIS-type junction can also be used in place of an optical sensor using a PIN junction. For example, a method for forming a TFT with a bottom gate structure (reverse stagger structure) using an amorphous Si film and a photodiode having an MIS-type junction monolithically on the same substrate is known, for example, as disclosed by JP 6(1994)-188400 A, and this method would be obvious to those skilled in the art. Therefore, the detailed description thereof will be omitted.

The present invention can be widely applied to a flat panel type display apparatus with an active element, and can be applied to various kinds of display apparatuses such as an EL display apparatus and an electrophoresis display apparatus, in addition to the liquid crystal display apparatus.

Furthermore, in each of the above embodiments, the display apparatus has been described in which an optical sensor is formed in the peripheral region 9 as a representative of an environment sensor. However, a temperature sensor, a humidity sensor, a color sensor of a backlight, or a lightness sensor can be adopted as an environment sensor in place of the optical sensor, and the same effects are obtained.

### Second Embodiment

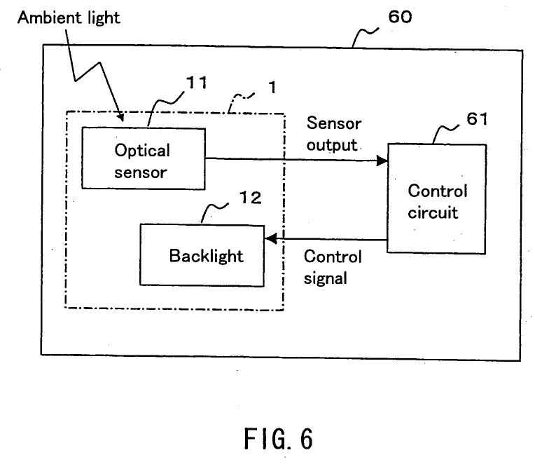

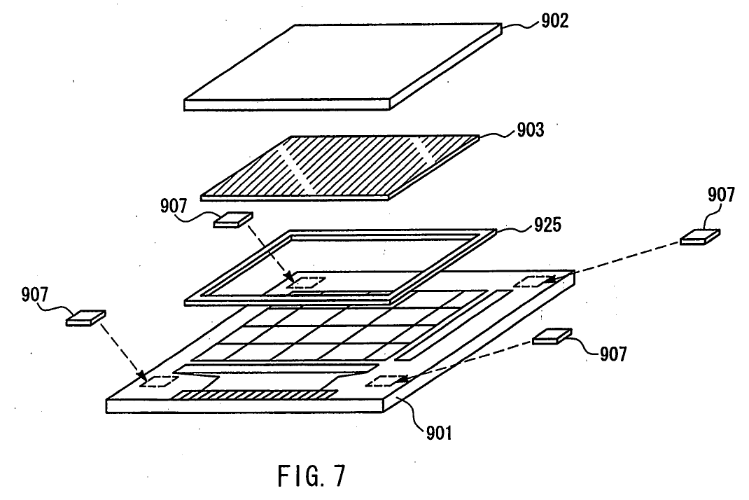

FIG. 6 shows a schematic configuration of an electronic device according to one embodiment of the present invention. As shown in FIG. 6, an electronic device 60 according to the present embodiment includes the display apparatus 1 according to First Embodiment, and a control circuit 61 that controls the display brightness of the display apparatus 1 in accordance with the lightness information of ambient light detected by the optical sensor 11 of the display apparatus 1. In FIG. 6, the functional blocks in the display apparatus 1 and the electronic device 60 are abbreviated. The control circuit 61 may have a function of controlling any operation of the electronic device 60 in addition to the control of the display brightness. Furthermore, the electronic device 60 can have any functional blocks other than those shown in FIG. 6 depending upon the application thereof and the like.

The control circuit 61 controls the display brightness of the display apparatus 1 by adjusting the brightness of the backlight system 12 in accordance with the lightness information (sensor output) of ambient light detected by the optical sensor 11. For example, if the adjustment of a brightness (light control) is performed automatically so that the display brightness is increased in a light environment such as the outdoor, and the display brightness is decreased in a relatively dark environment such as the nighttime and the indoor, the reduction in power consumption and the increase in life of the display apparatus can be realized. In the case of using a semi-transmission display mode using both a transmission display mode and a reflection display mode, the brightness of a backlight system can be decreased or the backlight can be turned off in a light environment such as the outdoor, so that the reduction in power consumption and the increase in life of the display apparatus can be realized further. Since the display apparatus 1 is a liquid crystal display apparatus, the display brightness thereof can be adjusted by controlling the brightness of a backlight system. In the case of using a self-light emitting element such as an EL element as a display apparatus, the control circuit 61 is configured so as to control the emission brightness of the self-light emitting element.

Thus, by controlling the display brightness so as to obtain a necessary and sufficient brightness in accordance with the lightness of the circumstance, an electronic device that reduces power consumption and realizes an easy-to-see display can be provided. The electronic device of the present embodiment can satisfy both the satisfactory visibility and the reduction in power consumption with respect to the change in lightness of a use environment, so that it is particularly useful as a mobile device which is likely to be used outdoors and requires the driving of a battery. Specific examples of such a mobile device are not limited to the application of the present invention, and include, for example, an information terminal such as a mobile telephone and a PDA, a mobile game device, a portable music player, a digital camera, and a video camera.

In the present embodiment, although the configuration in which the control circuit 61 for controlling the display brightness of the display apparatus is provided outside of the display apparatus has been illustrated, the control circuit may be provided as a part of the display apparatus.

### INDUSTRIAL APPLICABILITY

The present invention can be applied to a flat panel type display apparatus provided with an environment sensor and an electronic device having the flat panel type display apparatus.

1. A display apparatus, comprising:
an active matrix substrate having a pixel array region in which a plurality of pixels are arranged;
a counter substrate placed so as to be opposed to the pixel array region of the active matrix substrate; and
a display medium placed in a gap between the active matrix substrate and the counter substrate,
wherein in the pixel array region of the active matrix substrate, a plurality of electrode wires, a plurality of active elements, an interlayer insulation film provided in an upper layer of the plurality of electrode wires and the plurality of active elements, and a plurality of pixel electrodes formed on the interlayer insulation film,
the display apparatus comprising an environment sensor provided in a peripheral region present on a periphery of the pixel array region in the active matrix substrate, and
a surface protective film provided in an upper layer of the environment sensor,
wherein the surface protective film includes a transparent insulation layer having an effect of attenuating UV-light transmittance, formed of the same material as that of the interlayer insulation film in the pixel array region, and a transparent conductive layer formed of the same material as that of the pixel electrode in an upper layer of the transparent insulation layer.

2. The display apparatus according to claim 1, wherein at least partial constituent members of the environment sensor are produced by the same process as that of constituent members of the active elements.

3. The display apparatus according to claim 1, wherein the environment sensor is formed monolithically on a principal plane of the active matrix substrate.

4. The display apparatus according to claim 1, wherein the interlayer insulation film and the transparent insulation layer are formed by the same process, and the pixel electrodes and the transparent conductive layer are formed by the same process.

5. The display apparatus according to claim 1, wherein the active elements are thin film transistors, and the environment sensor is a photodiode having a lateral structure.

6. The display apparatus according to claim 1, wherein the transparent conductive layer attenuates a transmittance of UV-light contained in ambient light to 50% or less.

7. The display apparatus according to claim 6, wherein the transparent conductive layer is an indium-tin oxide, and a thickness thereof is 140 nm or more.

8. The display apparatus according to claim 1, wherein the transparent conductive layer is electrically insulated from the pixel electrode, and is connected to a predetermined fixed potential.

9. An electronic device having the display apparatus according to claim 1,
wherein the environment sensor is an optical sensor, and
the electronic device includes a control circuit controlling a display brightness in accordance with lightness information of ambient light detected by the optical sensor.

10. An active matrix substrate having a pixel array region in which a plurality of pixels are arranged, comprising:
in the pixel array region, a plurality of electrode wires, a plurality of active elements, an interlayer insulation film provided in an upper layer of the plurality of electrode wires and a plurality of active elements, and a plurality of pixel electrodes formed on the interlayer insulation film;
an environment sensor provided in a peripheral region present on a periphery of the pixel array region in the active matrix substrate; and
a surface protective film provided in an upper layer of the environment sensor,
wherein the surface protective film includes a transparent insulation layer having an effect of attenuating a UV-light transmittance, formed of the same material as that of the interlayer insulation film in the pixel array region, and a transparent conductive layer formed of the same material as that of the pixel electrode in an upper layer of the transparent insulation layer.
